(19) United States
(12) Patent Application Publication
(10) Pub. No.: US 2019/0294314 A1
(43) Pub. Date: Sep. 26, 2019

(54) IMAGE DISPLAY DEVICE, IMAGE DISPLAY METHOD, AND COMPUTER READABLE RECORDING DEVICE

(71) Applicant: NURVE, Inc., Tokyo (JP)

(72) Inventors: Hideki TADA, Tokyo (JP); Reishi OYA, Tokyo (JP)

(21) Appl. No.: 16/281,483

(22) Filed: Feb. 21, 2019

Related U.S. Application Data
(63) Continuation of application No. PCT/JP2017/030052, filed on Aug. 23, 2017.

(30) Foreign Application Priority Data
Aug. 24, 2016 (JP) 2016-163382

(51) Int. Cl. G06F 3/0481; G06K 9/00; G06T 19/00; G06F 3/01; G06F 3/0484

(52) U.S. Cl. CPC G06F 3/04815; G06K 9/00624; G06F 3/011; G06F 3/017; G06F 3/04842; G06T 19/00

(57) ABSTRACT

An image display device is provided with: an outside information obtaining unit that obtains information related to a real-life space in which the image display device exists; an object recognition unit that recognizes, based on the information, a particular object that exists in the real-life space; a pseudo three-dimensional rendering processing unit that places an image of the object in a particular plane within the virtual space; a virtual space configuration unit that provides, in the plane, a plurality of determination points used for recognizing the image of the object and that places, in the plane, a manipulation object that is manipulated by the image of the object; a state determination unit that determines whether each of the plurality of determination points is in either a first state, in which the image of the object is superimposed, or in a second state, in which the image of the object is not superimposed; and a position update processing unit that updates a position of the manipulation object depending on a determination result by the state determination unit.

### CROSS-REFERENCE TO RELATED APPLICATION(S)

This application is a continuation application of PCT International Application No. PCT/JP2017/030052 filed on Aug. 23, 2017, which designated the United States, and which claims the benefit of priority from Japanese Patent Application No. 2016-163382, filed on Aug. 24, 2016. The entire contents of these applications are incorporated herein by reference.

### BACKGROUND OF THE INVENTION

### Field of the Invention

The present invention relates to a technique for displaying a user interface in a virtual space.

### Description of the Related Art

In recent years, a technique for allowing users to experience virtual reality (hereinafter also referred to as “VR”) has been utilized in various fields including games, entertainment, vocational training, and others. In VR, spectacle-type or goggle-type display devices referred to as head-mounted displays (hereinafter also referred to as “HMDs”) are typically used. Users can appreciate stereoscopic images by wearing the HMDs on their heads and looking at screens built into the HMDs with both eyes. Gyroscope sensors and acceleration sensors are embedded in the HMDs and images displayed on the screens change depending on the movements of the users' heads detected by these sensors. This allows users to have an experience as if they are in the displayed image.

In such technical field of VR, research has been made on user interfaces that perform manipulations through user gestures. As an example, a technique is known in which manipulations according to the users' movements are performed with respect to the HMDs by attaching dedicated sensors to the body surfaces of the users or by arranging external devices around users for detecting the users' movements.

As another example, JP2012-48656 A discloses an image processing device which determines that a manipulation has been made to a user interface if, with the user interface being deployed in a virtual space, a manipulation unit to be used by a user for manipulating the user interface is within a field of view of an imaging unit and if the positional relationship between the manipulation unit and the user interface has a specified positional relationship.

### BRIEF SUMMARY OF THE INVENTION

An aspect of the present invention relates to an image display device. The image display device is a device that is capable of displaying a screen for allowing a user to perceive a virtual space. The device is provided with: an outside information obtaining unit that obtains information related to a real-life space in which the image display device exists; an object recognition unit that recognizes, based on the information, a particular object that exists in the real-life space; a pseudo three-dimensional rendering processing unit that places an image of the object in a particular plane within the virtual space; a virtual space configuration unit that provides, in the plane, a plurality of determination points used for recognizing the image of the object and that places, in the plane, a manipulation object that is manipulated by the image of the object and that moves over the plurality of determination points; a state determination unit that determines whether each of the plurality of determination points is in either a first state, in which the image of the object is superimposed, or in a second state, in which the image of the object is not superimposed; and a position update processing unit that updates a position of the manipulation object depending on a determination result by the state determination unit.

Another aspect of the present invention relates to an image display method. The image display method is a method that is executed by an image display device that is capable of displaying a screen for allowing a user to perceive a virtual space. The method includes the steps of: (a) obtaining information related to a real-life space in which the image display device exists; (b) recognizing, based on the information, a particular object that exists in the real-life space; (c) placing an image of the object in a particular plane within the virtual space; (d) providing, in the plane, a plurality of determination points used for recognizing the image of the object and placing, in the plane, a manipulation object that is manipulated by the image of the object and that moves over the plurality of determination points; (e) determining whether each of the plurality of determination points is in either a first state, in which the image of the object is superimposed, or in a second state, in which the image of the object is not superimposed; and (f) updating a position of the manipulation object depending on a determination result in step (e).

A further aspect of the present invention relates to a computer-readable recording device. The computer-readable recording device has an image display program stored thereon to be executed by an image display device that is capable of displaying a screen for allowing a user to perceive a virtual space. The image display program causes the image display device to execute the steps of: (a) obtaining information related to a real-life space in which the image display device exists; (b) recognizing, based on the information, a particular object that exists in the real-life space; (c) placing an image of the object in a particular plane within the virtual space; (d) providing, in the plane, a plurality of determination points used for recognizing the image of the object and placing, in the plane, a manipulation object that is manipulated by the image of the object and that moves over the plurality of determination points; (e) determining whether each of the plurality of determination points is in either a first state, in which the image of the object is superimposed, or in a second state, in which the image of the object is not superimposed; and (f) updating a position of the manipulation object depending on a determination result in step (e).

The above-described and other features, advantages and technical and industrial significance of the present invention, will be better understood by reading the following detailed description of the current preferred embodiments of the present invention while considering the attached drawings.

### BRIEF DESCRIPTION OF THE DRAWINGS

FIG. 1 is a block diagram showing a schematic configuration of an image display device according to a first embodiment of the present invention.

FIG. 2 is a schematic diagram showing the state in which a user is wearing an image display device.

FIG. 3 is a schematic diagram illustrating a screen displayed on a display unit shown in FIG. 1.

FIG. 4 is a schematic diagram illustrating a virtual space corresponding to the screen shown in FIG. 3.

FIG. 5 is a schematic diagram illustrating a manipulation plane deployed in the virtual space in the first embodiment of the present invention.

FIG. 6 is a schematic diagram illustrating a screen in which an image of a particular object is superimposed and displayed on the manipulation plane shown in FIG. 5.

FIG. 7 is a flowchart illustrating operations of the image display device according to the first embodiment of the present invention.

FIG. 8 is a schematic diagram illustrating a manipulation plane deployed in the virtual space in the first embodiment of the present invention.

FIG. 9 is a flowchart illustrating processing of accepting a manipulation.

FIG. 10 is a schematic diagram for describing the processing of accepting a manipulation.

FIG. 11 is a flowchart illustrating follow-up processing.

FIG. 12 is a schematic diagram for describing the follow-up processing.

FIG. 13 is a schematic diagram for describing the follow-up processing.

FIG. 14 is a schematic diagram for describing the follow-up processing.

FIG. 15 is a schematic diagram for describing the follow-up processing.

FIG. 16 is a schematic diagram for describing the follow-up processing.

FIG. 17 is a schematic diagram for describing a determination method at the time of terminating selection determination processing.

FIG. 18 is a schematic diagram for describing a method of determining whether a selection has been made.

FIG. 19 is a schematic diagram for describing a method of determining a selected menu.

FIG. 20 is a schematic diagram showing another arrangement example of determination points in the manipulation plane.

FIG. 21 is a schematic diagram illustrating a manipulation plane deployed in the virtual space in a second embodiment of the present invention.

FIG. 22 is a flowchart illustrating operations of an image processing device according to the second embodiment of the present invention.

FIG. 23 is a schematic diagram for describing an example of a manipulation to the manipulation plane shown in FIG. 22.

FIG. 24 is a schematic diagram for describing an example of a manipulation to the manipulation plane shown in FIG. 22.

FIG. 25 is a schematic diagram for describing an example of a manipulation to the manipulation plane shown in FIG. 22.

FIG. 26 is a schematic diagram for describing an example of a manipulation to the manipulation plane shown in FIG. 22.

FIG. 27 is a schematic diagram for describing an example of a manipulation to the manipulation plane shown in FIG. 22.

FIG. 28 is a schematic diagram for describing an example of a manipulation to the manipulation plane shown in FIG. 22.

FIG. 29 is a schematic diagram for describing an example of a manipulation to the manipulation plane shown in FIG. 22.

FIG. 30 is a schematic diagram illustrating a manipulation plane deployed in the virtual space in a third embodiment of the present invention.

### DETAILED DESCRIPTION OF THE INVENTION

The display device according to embodiments of the present invention will be described hereinafter with reference to the drawings. It should be understood that the present invention is not limited by these embodiments. In the descriptions of the respective drawings, the same parts are indicated by providing the same reference numerals.

### First Embodiment

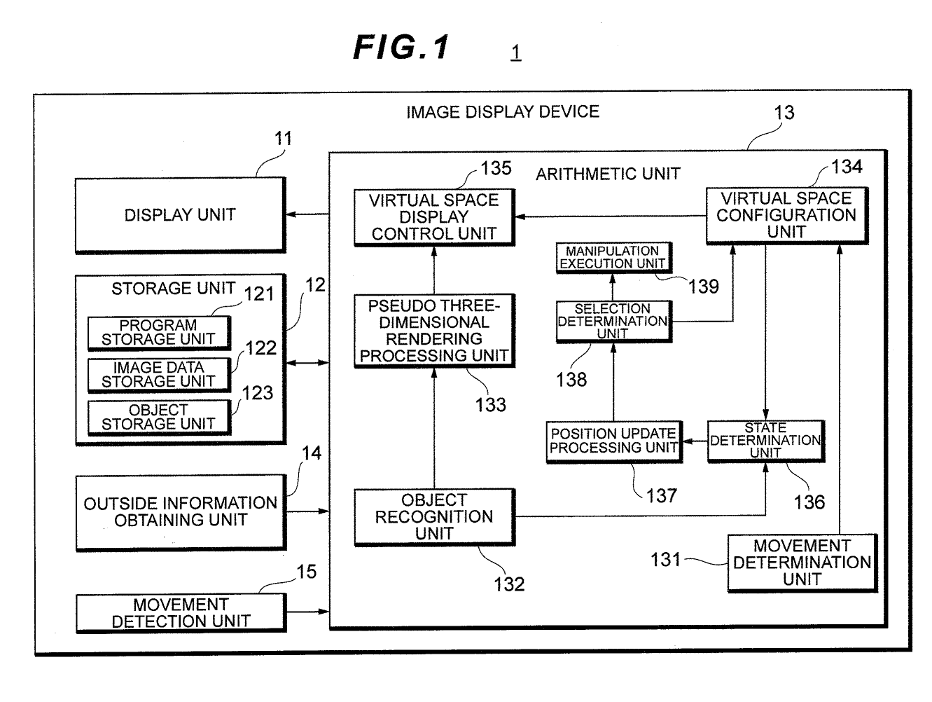

FIG. 1 is a block diagram showing a schematic configuration of the image display device according to a first embodiment of the present invention. The image display device 1 according to the present embodiment is a device which allows a user to perceive a three-dimensional virtual space by making the user see a screen with both of his/her eyes. As shown in FIG. 1, the image display device 1 is provided with: a display unit 11 on which a screen is displayed; a storage unit 12; an arithmetic unit 13 that performs various kinds of arithmetic processing; an outside information obtaining unit 14 that obtains information related to the outside of the image display device 1 (hereinafter referred to as “outside information”); and a movement detection unit 15 that detects movements of the image display device 1.

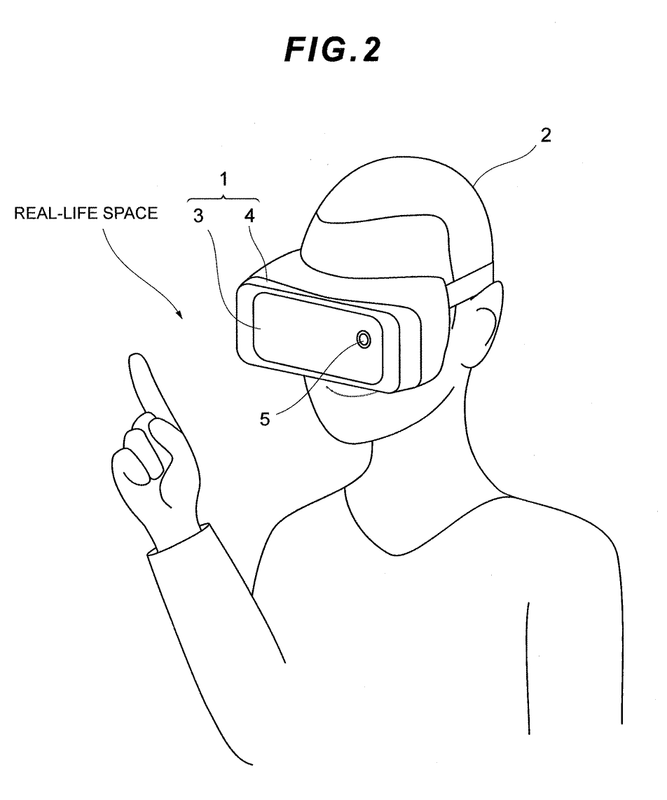

FIG. 2 is a schematic diagram showing the state in which a user 2 is wearing the image display device 1. As shown in FIG. 2, the image display device 1 may be configured, for example, by attaching a general-purpose display device 3 provided with a display and a camera, such as a smartphone, a personal digital assistant (PDA), a portable game device, or the like, to a holder 4. In this case, the display device 3 may be attached with the display provided on the front surface facing inside of the holder 4 and the camera 5 provided on the back surface facing outside of the holder 4. Inside the holder 4, respective lenses are provided at positions corresponding to the user's right and left eyes, and the user 2 sees the display of the display device 3 through these lenses. Moreover, the user 2 can see the screen displayed on the image display device 1 in a hands-free manner by wearing the holder 4 on his/her head.

The appearance of the display device 3 and the holder 4 is not, however, limited to that shown in FIG. 2. For example, a simple box-type holder having lenses incorporated therein may be used instead of the holder 4. A dedicated image display device having a display, an arithmetic device and a holder integrated together may be used. Such dedicated image display device may also be referred to as a head-mounted display.

Referring to FIG. 1 again, the display unit 11 is a display that includes a display panel formed by, for example, liquid crystal or organic EL (electroluminescence) and a drive unit.

The storage unit 12 is a computer-readable storage medium, such as semiconductor memory, for example, ROM, RAM or the like. The storage unit 12 includes: a program storage unit 121 that stores, in addition to an operating system program and a driver program, application programs that execute various functions, various parameters that are used during execution of these programs, and the like; an image data storage unit 122 that stores image data of content (still images or videos) to be displayed on the display unit 11; and an object storage unit 123 that stores image data of the user interface used at the time of performing an input manipulation during content display. Additionally, the storage unit 12 may store audio data of voice or sound effects to be output during the execution of various applications.

The arithmetic unit 13: is configured with, for example, a CPU (Central Processing Unit) or a GPU (Graphics Processing Unit); controls the respective units of the image display device 1 in an integrated manner and executes various kinds of arithmetic processing for displaying different images, by reading various programs stored in the program storage unit 121. The detailed configuration of the arithmetic unit 13 will be described later.

The outside information obtaining unit 14 obtains information regarding the real-life space in which the image display device 1 actually exists. The configuration of the outside information obtaining unit 14 is not particularly limited, as long as it can detect positions and movements of an object that actually exists in the real-life space. For example, an optical camera, an infrared camera, an ultrasonic transmitter and receiver, and the like, may be used as the outside information obtaining unit 14. In the present embodiment, the camera 5 incorporated in the display device 3 will be used as the outside information obtaining unit 14.

The movement detection unit 15 includes, for example, a gyroscope sensor and an acceleration sensor and detects the movements of the image display device 1. The image display device 1 can detect the state of the head of the user 2 (whether stationary or not), the eye direction (upward or downward direction) of the user 2, the relative change in the eye direction of the user 2, and the like, based on the detection result of the movement detection unit 15.

Next, the detailed configuration of the arithmetic unit 13 will be described. The arithmetic unit 13 causes the display unit 11 to display a screen for allowing the user 2 to perceive the three-dimensionally configured virtual space and executes an operation for accepting an input manipulation through gestures by the user 2, by reading an image display program stored in the program storage unit 121.

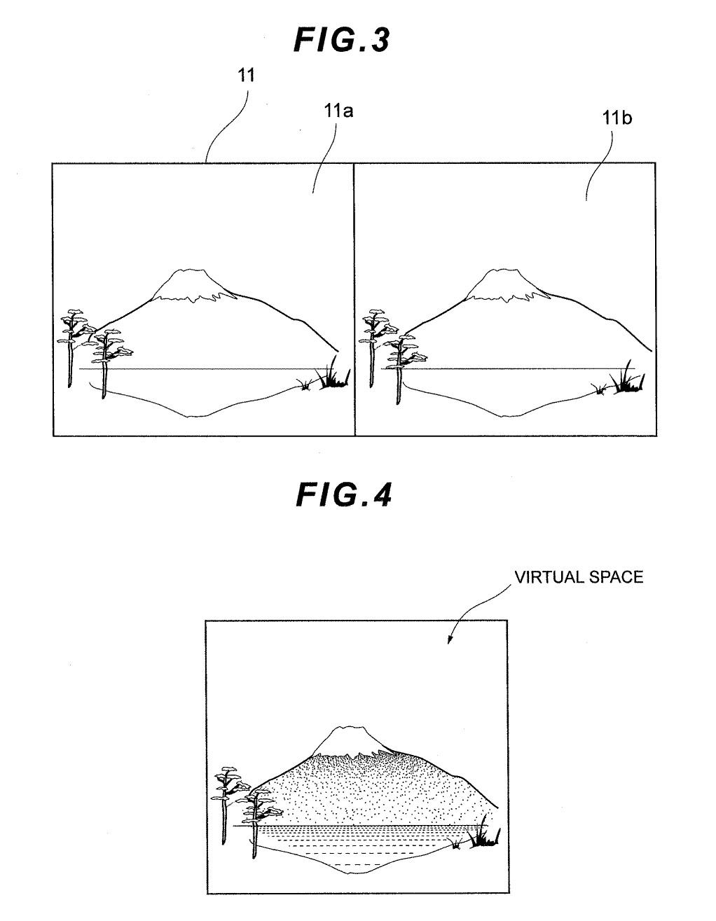

FIG. 3 is a schematic diagram showing an example of the screens displayed on the display unit 11. FIG. 4 is a schematic diagram showing an example of the virtual space corresponding to the screens shown in FIG. 3. When displaying still image or video content as the virtual space, as shown in FIG. 3, the display panel of the display unit 11 is divided into two regions and two screens 11a, 11b provided with parallax with respect to each other are displayed in these regions. The user 2 can perceive the three-dimensional image (i.e. the virtual space) such as shown in FIG. 4 by respectively looking at the screens 11a, 11b with his/her right and left eyes.

As shown in FIG. 1, the arithmetic unit 13 is provided with: a movement determination unit 131; an object recognition unit 132; a pseudo three-dimensional rendering processing unit 133; a virtual space configuration unit 134; a virtual space display control unit 135; a state determination unit 136; a position update processing unit 137; a selection determination unit 138; and a manipulation execution unit 139.

The movement determination unit 131 determines the movement of the head of the user 2 based on a detection signal output from the movement detection unit 15. More specifically, the movement determination unit 131 determines whether the user's head is still or not, in which direction the head is directed toward if the head is moving, and so on.

The object recognition unit 132 recognizes a particular object that actually exists in the real-life space based on the outside information obtained by the outside information obtaining unit 14. As described above, when the camera 5 (see FIG. 2) is used as the outside information obtaining unit 14, the object recognition unit 132 recognizes an object that has a predetermined feature through image processing performed on an image of the real-life space obtained by the camera 5 imaging the real-life space. The particular object to be recognized (i.e. the recognition target) may be a hand or finger of the user 2, or it may be an object, such as a stylus pen, a stick, or the like.

The feature used when recognizing the particular object may be determined in advance depending on the recognition target. For example, when a hand or finger of the user 2 is to be recognized, the object recognition unit 132 may, for example, extract pixels having color feature amounts within the skin color range (the respective pixel values of R, G, B, their color ratios, the color differences, etc.) and may extract a region where equal to or more than a predetermined number of these pixels are concentrated as the region where the finger or hand is captured. Alternatively, the region where the finger or hand is captured may be extracted based on the area or circumference of the region where the extracted pixels are concentrated.

The pseudo three-dimensional rendering processing unit 133 executes processing for placing an image of the particular object recognized by the object recognition unit 132 in a particular plane within the virtual space. In particular, the pseudo three-dimensional rendering processing unit 133 arranges the image of the particular object in a manipulation plane, which is deployed in the virtual space as a user interface. More specifically, the pseudo three-dimensional rendering processing unit 133 produces a two-dimensional image that includes the image of the particular object and performs processing for allowing the user to perceive the image of such object as if it were present in a plane within the three-dimensional virtual space by setting the parallax such that the two-dimensional image has the same sense of depth as that of the manipulation plane displayed in the virtual space.

The virtual space configuration unit 134 performs placement, and the like, of the object in the virtual space to be perceived by the user. More specifically, the virtual space configuration unit 134 reads out image data from the image data storage unit 122 and cuts out a partial region (a region within the user's field of view) from the entire image represented by the image data depending on the user's head state or varies the sense of depth of an object in the image.

The virtual space configuration unit 134 also reads out image data of the manipulation plane, which is used when the user performs manipulations through gestures, from the object storage unit 123 and deploys the manipulation plane in a particular plane within the virtual space based on such image data.

The virtual space display control unit 135 combines the two-dimensional image produced by the pseudo three-dimensional rendering processing unit 133 with the virtual space configured by the virtual space configuration unit 134 and causes the display unit 11 to display the combination.

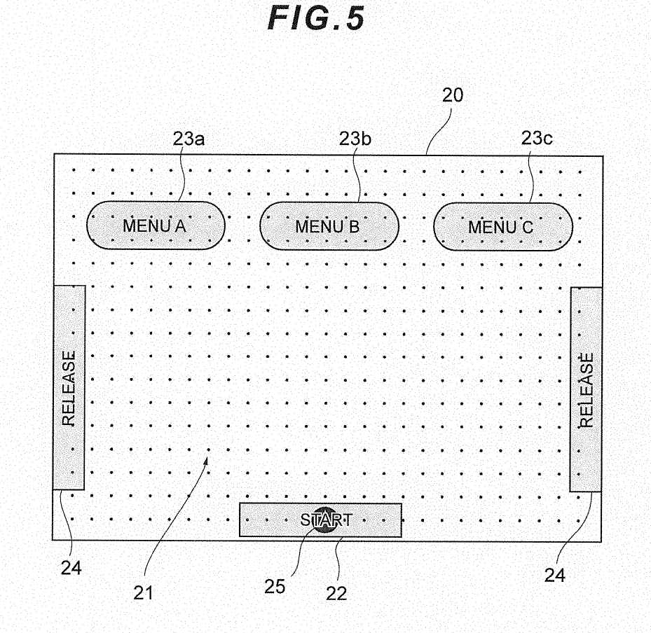

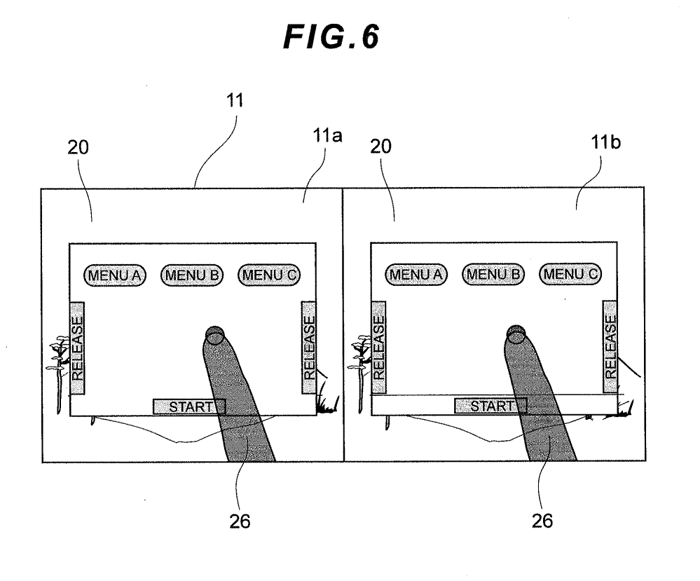

FIG. 5 is a schematic diagram illustrating a manipulation plane to be deployed in the virtual space. FIG. 6 is a schematic diagram illustrating a screen in which the two-dimensional image produced by the pseudo three-dimensional rendering processing unit 133 is superimposed and displayed on the manipulation plane 20 shown in FIG. 5. In FIG. 6, an image of the user's finger (hereinafter referred to as the “finger image”) 26 is displayed as the particular object to be used for gestures with respect to the manipulation plane 20.

The manipulation plane 20 shown in FIG. 5 is a user interface for the user to select a desired selection target from among a plurality of selection targets. As shown in FIG. 5, the manipulation plane 20 is pre-provided with a plurality of determination points 21 for recognizing the image of the particular object (e.g. finger image 26) to be used for gestures. A start area 22, menu items 23a to 23c, a release area 24 and a manipulation object 25 are placed so as to superimpose the determination points 21.

Each of the plurality of determination points 21 is associated with a coordinate fixed on the manipulation plane 20. In FIG. 5, the determination points 21 are arranged in a grid; however, the arrangement of the determination points 21 and the interval between the neighboring determination points 21 are not limited thereto. It is sufficient if the determination points 21 are arranged to cover the extent in which the manipulation object 25 is moved. Moreover, in FIG. 5, the determination points 21 are shown in dots; however, it is unnecessary to display the determination points 21 when displaying the manipulation plane 20 on the display unit 11 (see FIG. 6).

The manipulation object 25 is an icon of an object to be manipulated by the user in a virtual manner and is configured to move over the determination points 21 in a discrete manner. The position of the manipulation object 25 appears to change in such a manner that it follows the movement of the finger image 26, based on the positional relationship between the finger image 26 and the determination points 21. In FIG. 5, the shape of the manipulation object 25 is circular; however, the shape and size of the manipulation object 25 are not limited to those shown in FIG. 5 and they may be appropriately set depending on the size of the manipulation plane 20, the object to be used for gestures, and the like. For example, a bar-like icon, an arrow-like icon, and the like, may be used as the manipulation object.

Each of the start area 22, the menu items 23a to 23c and the release area 24 is associated with a position of the determination point 21. Among the above elements, the start area 22 is provided as a trigger for starting follow-up processing of the finger image 26 by the manipulation object 25. Immediately after the opening of the manipulation plane 20, the manipulation object 25 is placed in the start area 22, and the finger image 26 follow-up processing by the manipulation object 25 starts when it is determined that the finger image 26 is superimposed on the start area 22.

The menu items 23a to 23c are icons that each represents a corresponding selection target (selection object). When it is determined, during the finger image 26 follow-up processing by the manipulation object 25, that the manipulation object 25 is superimposed on any of the menu items 23a to 23c, then it is determined that the selection target corresponding to the menu item being superimposed is selected and the finger image 26 follow-up processing by the manipulation object 25 is released.

The release area 24 is provided as a trigger for releasing the finger image 26 follow-up processing by the manipulation object 25. When it is determined, during the finger image 26 follow-up processing by the manipulation object 25, that the manipulation object 25 is superimposed on the release area 24, the finger image 26 follow-up processing by the the manipulation object 25 is released.

The object shape and size and arrangement of these start area 22, menu items 23a to 23c and release area 24 are not limited to those shown in FIG. 5, and they may be appropriately set depending on the number of menu items corresponding to selection targets, the relative size or shape of the finger image 26 with respect to the manipulation plane 20, the size or shape of the manipulation object 25, or the like.

The state determination unit 136 determines the respective states of the plurality of determination points 21 provided in the manipulation plane 20. Here, the states of the determination point 21 include the state in which the finger image 26 is superimposed on the determination point 21 (the “on” state) and the state in which the finger image 26 is not superimposed on the determination point 21 (the “off” state). The states of the determination points 21 can be determined based on a pixel value of a pixel where each determination point 21 is located. For example, the determination point 21 at a pixel position having a color feature amount (pixel value, color ratio, color difference, etc.) similar to that of the finger image 26 is determined to be in the “on” state.

The position update processing unit 137 updates the position of the manipulation object 25 in the manipulation plane 20 in accordance with the determination result of the states of the respective determination points 21 made by the state determination unit 136. More specifically, the position update processing unit 137 changes the coordinates of the manipulation object 25 to the coordinates of the determination point 21 in the “on” state. At this point, when there is a plurality of determination points 21 that are in the “on” state, the coordinates of the manipulation object 25 may be updated to the coordinates of the determination point 21 that meets a predetermined condition.

The selection determination unit 138 determines whether or not a selection object placed in the manipulation plane 20 is selected based on the position of the manipulation object 25. For example, in FIG. 5, when the manipulation object 25 moves to the position of the determination point 21 associated with the menu item 23a (more specifically, to the determination point 21 having the position coinciding with that of the menu item 23a), the selection determination unit 138 determines that such menu item 23a is selected.

When it is determined that any of the plurality of selection targets is selected, the manipulation execution unit 139 executes a manipulation corresponding to the selected selection target. The substance of the manipulation is not particularly limited, as long as it is executable in the image display device 1. Specific examples include a manipulation to switch on or off the image display, a manipulation to switch a currently displayed image to another image, and the like.

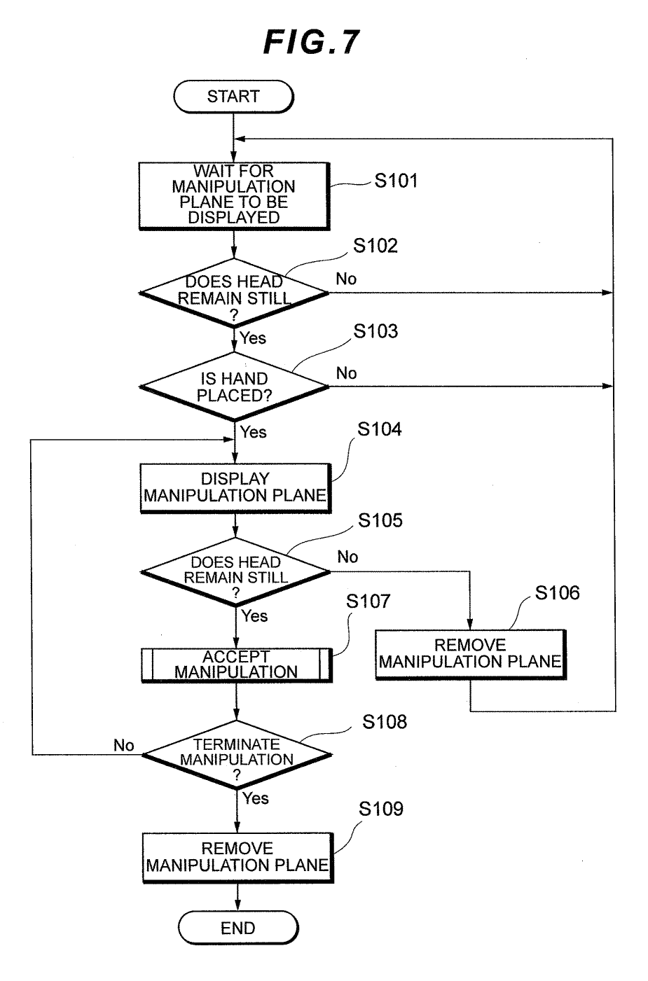

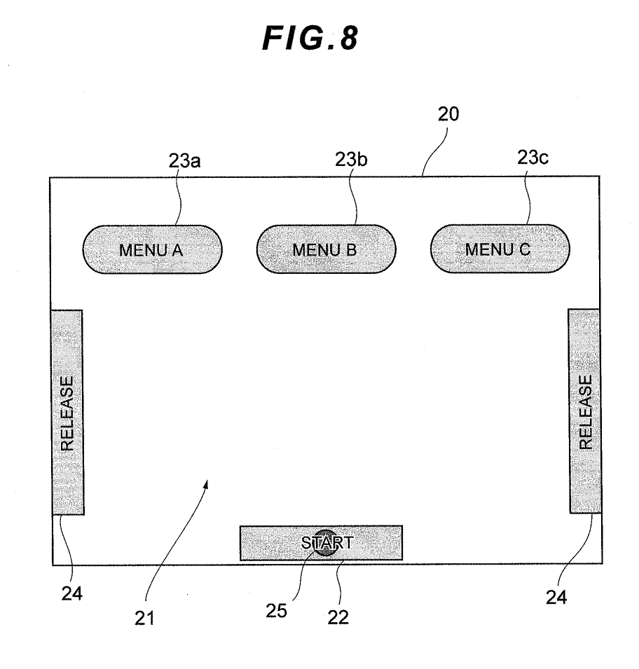

Next, the operations of the image display device 1 will be described. FIG. 7 is a flowchart illustrating the operations of the image display device 1 and such flowchart illustrates the operation of accepting an input manipulation through a gesture made by the user during execution of an image display program of the virtual space. FIG. 8 is a schematic diagram illustrating the manipulation plane 20 deployed in the virtual space in the present embodiment. It should be understood that, as described above, the determination points 21 provided in the manipulation plane 20 are not displayed on the display unit 11. Accordingly, the user perceives the manipulation plane 20 in the state shown in FIG. 8.

In step S101 of FIG. 7, the arithmetic unit 13 waits for the manipulation plane 20 to be displayed.

In the subsequent step S102, the arithmetic unit 13 determines whether or not the user's head remains still. Here, the head remaining still includes the state in which the user's head is slightly moving, in addition to the state in which the user's head is completely stationary. More specifically, the movement determination unit 131 determines whether or not the acceleration and angular acceleration of the image display device 1 (i.e. the head) are equal to or less than predetermined values based on the detection signals output from the movement detection unit 15. If the acceleration and angular acceleration exceed the predetermined values, the movement determination unit 131 determines that the user's head does not remain still (step S102: No). In this case, the operation of the arithmetic unit 13 returns to step S101 and continues to wait for the manipulation plane 20 to be displayed.

On the other hand, if the arithmetic unit 13 determines that the user's head remains still (step S102: Yes), it subsequently determines if the user is placing his/her hand over the camera 5 (see FIG. 2) (step S103). More specifically, the object recognition unit 132 determines whether or not a region where equal to or more than a predetermined number of pixels having a color feature amount of the hand (skin color) are concentrated exists by performing image processing on the image obtained by the camera 5. If the region where equal to or more than a predetermined number of pixels having a color feature amount of the hand are concentrated does not exist, the object recognition unit 132 determines that the user is not placing his/her hand over the camera 5 (step S103: No). In this case, the operation of the arithmetic unit 13 returns to step S101.

On the other hand, if the arithmetic unit 13 determines that the user is placing his/her hand over the camera 5 (step S103: Yes), it displays the manipulation plane 20 shown in FIG. 8 on the display unit 11 (step S104). At the beginning of the display of the manipulation plane 20, the manipulation object 25 is located in the start area 22. It should be noted that, if the user's head moves during this time, the arithmetic unit 13 displays the manipulation plane 20 in a manner such that it follows the movement of the user's head (i.e. the user's eye direction). The reason for this is that, if the manipulation plane 20 is fixed with respect to the background virtual space despite the user's eye direction change, the manipulation plane 20 will fall out of the user's field of view and the screen will become unnatural for the user trying to perform a next manipulation.

It should be understood that, in steps S103, S104, the user places his/her hand over the camera 5 for triggering the display of the manipulation plane 20; however, in addition to a hand, a predetermined object, such as a stylus pen, a stick, and the like, may be placed over the camera 5 for triggering the display.

In the subsequent step S105, the arithmetic unit 13 again determines whether or not the user's head remains still. If the arithmetic unit 13 determines that the user's head does not remain still (step S105: No), it removes the manipulation plane 20 (step S106). Then, the operation of the arithmetic unit 13 returns to step S101.

Here, the reason for making it a condition that the user's head remains still for displaying the manipulation plane 20 in steps S101, S105 is because, in general, a user will not operate the image display device 1 while moving his/her head greatly. Conversely, when the user is showing significant movement of his/her head, it can be considered that the user is immersed in the virtual space that he/she is viewing, and if the manipulation plane 20 is displayed at such times, the user will find it annoying.

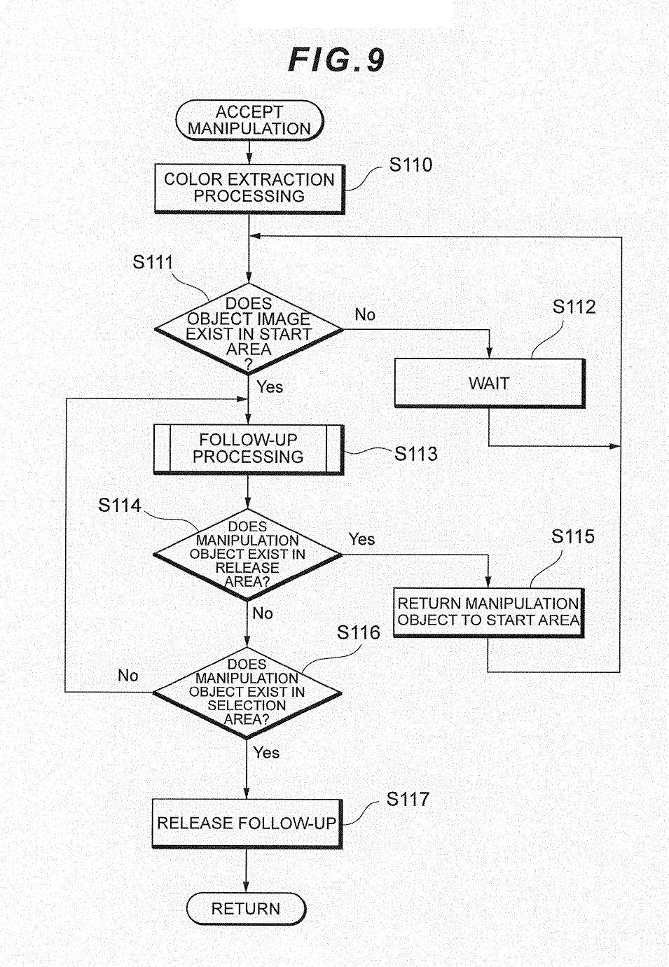

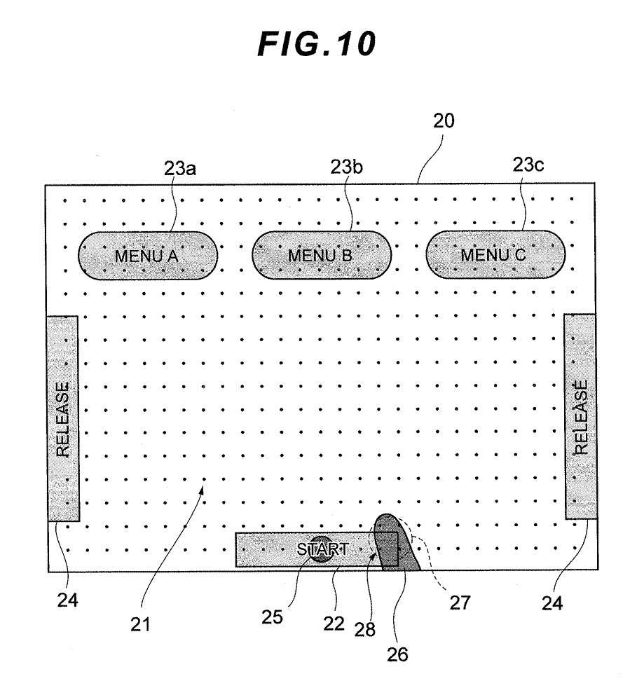

If the arithmetic unit 13 determines that the user's head remains still (step S105: Yes), it accepts a manipulation to the manipulation plane 20 (step S107). FIG. 9 is a flowchart illustrating processing of accepting a manipulation. FIG. 10 is a schematic diagram for describing the processing of accepting a manipulation. Hereinafter, the user's finger will be used as a particular object.

In step S110 of FIG. 9, the arithmetic unit 13 performs processing of extracting a region with a particular color, as a region in which the user's finger is captured, from the image of the real-life space obtained by the outside information obtaining unit 14. In particular, a region with the color of the user's finger, namely, the skin color is extracted. More specifically, a region where equal to or more than a predetermined number of pixels having a color feature amount of the skin color are concentrated is extracted by performing image processing on the real-life space image by the object recognition unit 132. The pseudo three-dimensional rendering processing unit 133 produces a two-dimensional image of the extracted region (i.e. the finger image 26) and the virtual space display control unit 135 superimposes such two-dimensional image on the manipulation plane 20 and causes the display unit 11 to display the outcome. It should be noted that the appearance of the finger image 26 displayed in the manipulation plane 20 is not particularly limited, as long as it has an appearance whereby the user can recognize the movement of his/her own finger. For example, it may be an image of a finger that is as realistic as that in the real-life space or it may be an image of a finger silhouette colored with a particular color.

In the subsequent step S111, the arithmetic unit 13 determines whether or not the image of an object, namely, the finger image 26 exists in the start area 22. More specifically, the state determination unit 136 extracts determination points 21 that are in the “on” state (i.e. the determination points 21 on which the finger image 26 is superimposed) from the plurality of determination points 21, and then determines whether or not determination points associated with the start area 22 are included in the extracted determination points. If the determination points associated with the start area 22 are included in the determination points that are in the “on” state, it is determined that the finger image 26 is in the start area 22.

For example, in the case of FIG. 10, the determination points 21 that are located in the region circled by the broken line 27 are extracted as the determination points in the “on” state, among which the determination point 28 that overlaps with the start area 22 corresponds to the determination point associated with the start area 22.

If the finger image 26 does not exist in the start area 22 (step S111: No), the state determination unit 136 waits for a predetermined time (step S112) and then again performs the determination in step S111. The length of such predetermined time is not particularly limited; however, as an example, it may be set to one-frame to a few-frame intervals based on the frame rate in the display unit 11.

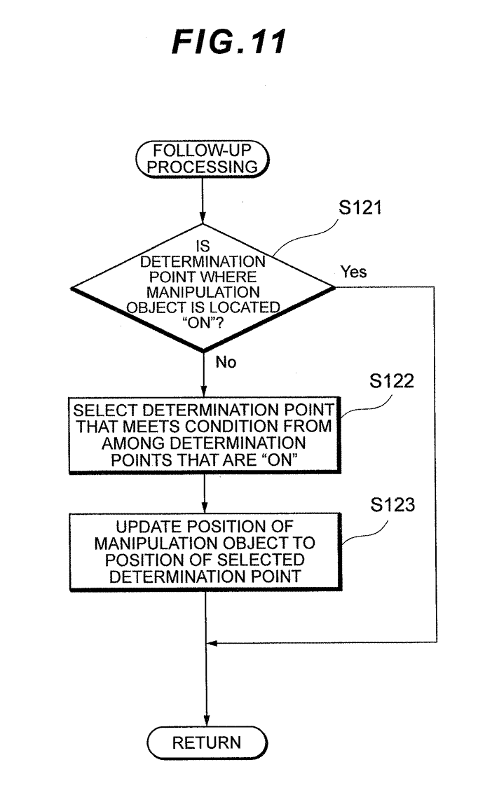

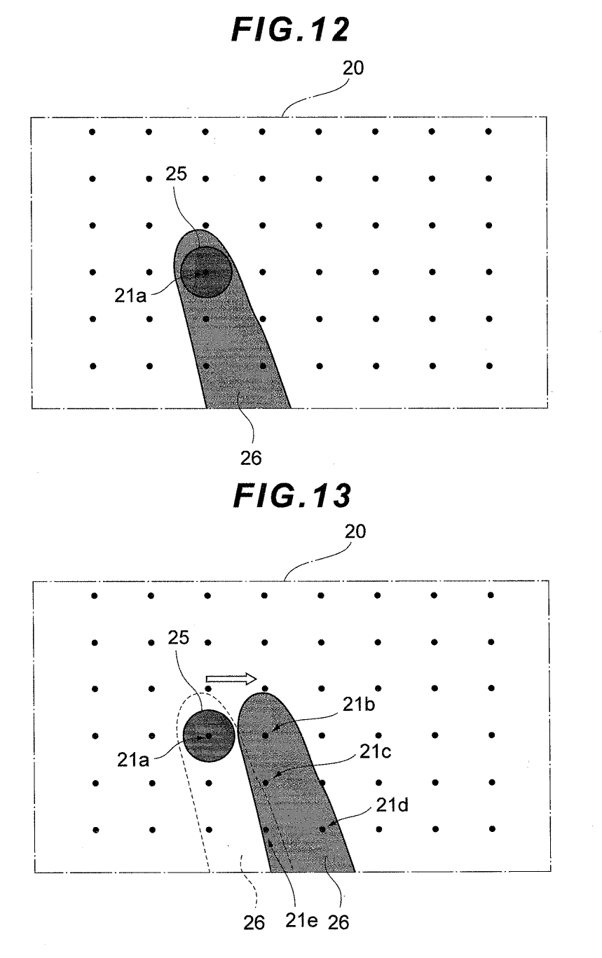

On the other hand, if the finger image 26 exits in the start area 22 (step S111: Yes), the arithmetic unit 13 executes the finger image 26 follow-up processing by the manipulation object 25 (step S113). FIG. 11 is a flowchart illustrating the follow-up processing. FIGS. 12 to 16 are schematic diagrams for describing the follow-up processing.

In step S121 of FIG. 11, the state determination unit 136 determines whether or not the determination point where the manipulation object 25 is located is in the “on” state. For example, in FIG. 12, the determination point 21a where the manipulation object 25 is located is in the “on” state since it is superimposed by the finger image 26 (step S121: Yes). In this case, the processing returns to the main routine.

On the other hand, as shown in FIG. 13, when the finger image 26 moves from the state shown in FIG. 12, the determination point 21a is now in the “off” state (step S121: No). In this case, the state determination unit 136 selects a determination point that meets a predetermined condition from among the determination points that are in the “on” state (step S122). In the present embodiment, as an example, the condition is the shortest distance from the determination point where the manipulation object 25 is currently located. For example, in the case of FIG. 13, the determination points 21b to 21e are now in the “on” state as a consequence of the movement of the finger image 26. Among these determination points 21b to 21e, since the determination point closest to the determination point 21a where the manipulation object 25 is currently located is the determination point 21b, it is the determination point 21b that will be selected.

Alternatively, as another example of the predetermined condition, a determination point that is closest to the tip of the finger image 26 may be selected from among the determination points that are in the “on” state. More specifically, the state determination unit 136 extracts a determination point that is located at an end in the region where the determination points that are in the “on” state are concentrated; namely, a determination point is extracted along the contour of the finger image 26. Then, three determination points that are adjacent to each other or have a predetermined interval with each other are further extracted, as a group, from among the extracted determination points, and the angles between these determination points are calculated. Such angle calculation may be sequentially performed on the determination points along the contour of the finger image 26 and a predetermined (for example, the middle) determination point may be selected from the group with the smallest angle.

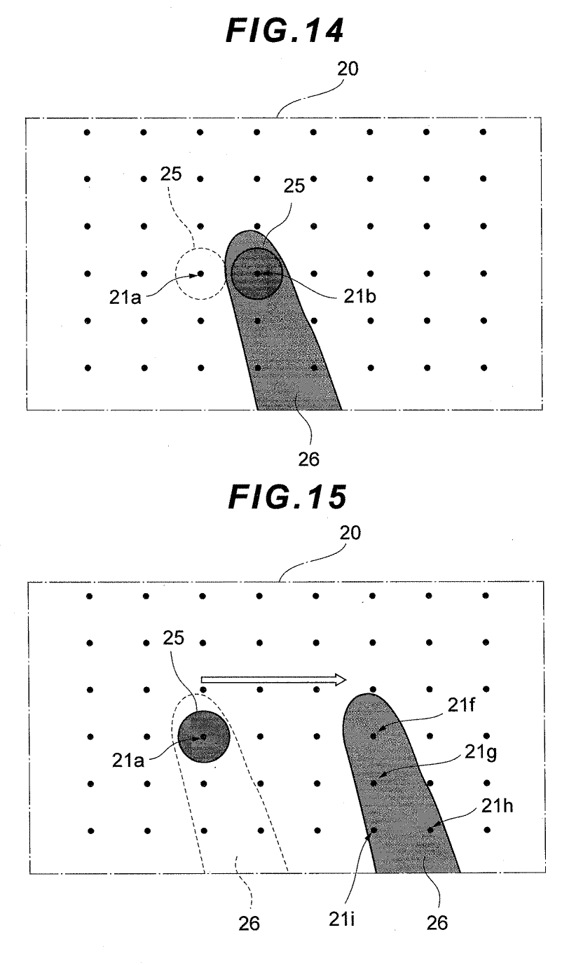

In the subsequent step S123, the position update processing unit 137 updates the position of the manipulation object 25 to the position of the selected determination point 21. For example, in the case of FIG. 13, the determination point 21b is selected and thus, as shown in FIG. 14, the position of the manipulation object 25 is updated from the position of the determination point 21a to the position of the determination point 21b. At this time, the user perceives this as if the manipulation object 25 has moved by following the finger image 26. The processing returns to the main routine thereafter.

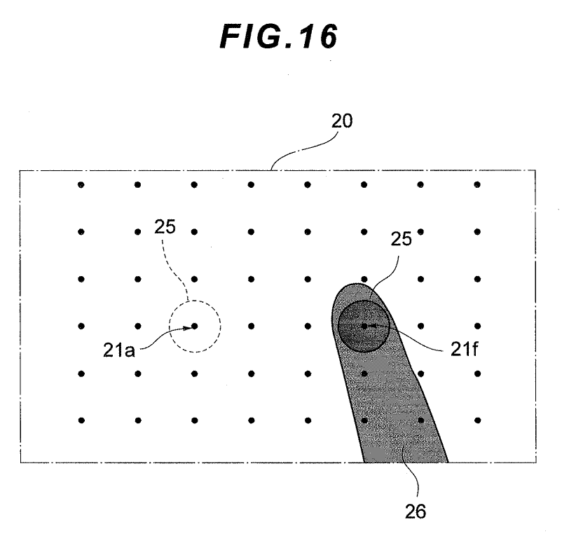

Here, the state determination unit 136 determines the state of the determination point 21 based only on its relationship with respect to the moved finger image 26 and the position update processing unit 137 updates the position of the manipulation object 25 according to the state of the determination point 21. Therefore, for example, as shown in FIG. 15, even when the finger image 26 moves fast, the determination points 21f to 21i are determined to be in the “on” state based on their relationships with the moved finger image 26. Among which, the determination point that is closest to the determination point 21a where the manipulation object 25 is currently located is the determination point 21f. Therefore, in this case, as shown in FIG. 16, the manipulation object 25 makes a jump from the position of the determination point 21a to the position of the determination point 21f. However, the manipulation object 25 is consequently displayed such that it is superimposed on the finger image 26 and thus, the user still perceives that the manipulation object 25 has moved by following the finger image 26.

Here, in step S121, the intervals for determining the state of the determination points 21 (i.e. the loop cycles of steps S113, S114, S116) may be appropriately set. As an example, the intervals may be set based on the frame rate of the display unit 11. For example, if the determinations are to be made in one-frame to a few-frame intervals, it appears to the user that the manipulation object 25 is naturally following the movement of the finger image 26.

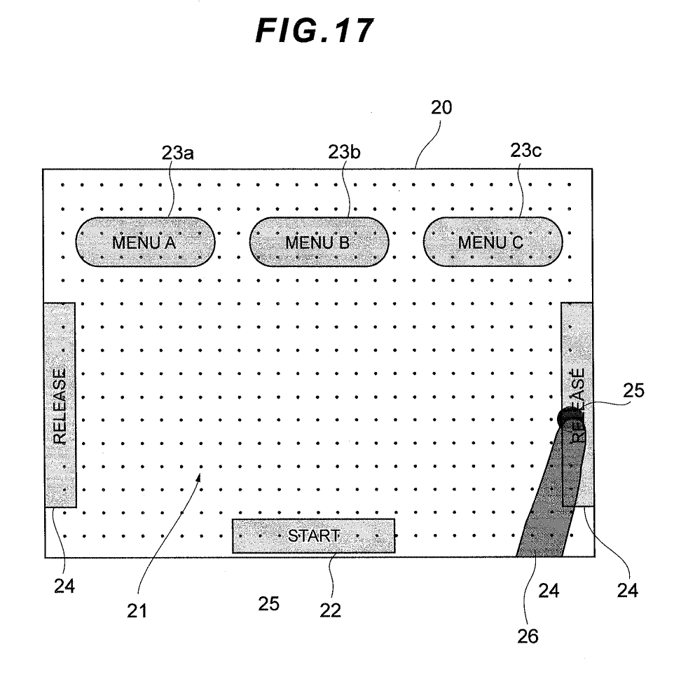

Referring to FIG. 9 again, in step S114, the arithmetic unit 13 determines whether or not the manipulation object 25 exists in the release area 24. More specifically, as shown in FIG. 17, the selection determination unit 138 determines whether or not the determination point 21 where the manipulation object 25 is located falls within the determination points 21 that are associated with the release area 24.

If it is determined that the manipulation object 25 exists in the release area 24 (step S114: Yes), the position update processing unit 137 returns the position of the manipulation object 25 to the start area 22 (step S115). Thereby, the manipulation object 25 moves away from the finger image 26 and the follow-up processing is prevented from being resumed until the finger image 26 is superimposed on the start area 22 again (see steps S111, S113); namely, the finger image 26 follow-up by the manipulation object 25 is released by moving the manipulation object 25 to the release area 24.

On the other hand, if it is determined that the manipulation object 25 does not exist in the release area 24 (step S114: No), the arithmetic unit 13 determines whether or not the manipulation object 25 exists in a selection area (step S116). More specifically, the selection determination unit 138 determines whether or not the determination point 21 at the position of the manipulation object 25 falls within the determination points 21 that are associated with any of the menu items 23a, 23b, 23c.

If it is determined that the manipulation object 25 dose not exist in the selection area (i.e. the menu items 23a, 23b, 23c) (step S116: No), the processing returns to step S113. In this case, the finger image 26 follow-up by the manipulation object 25 is continued.

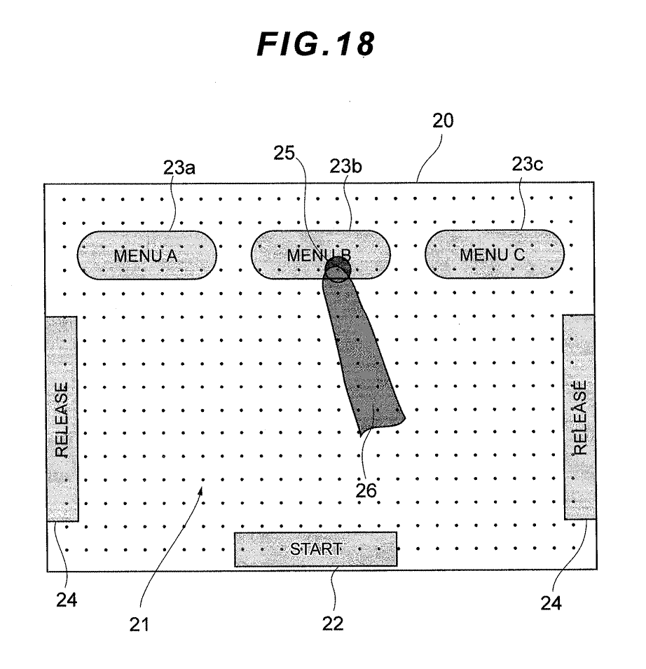

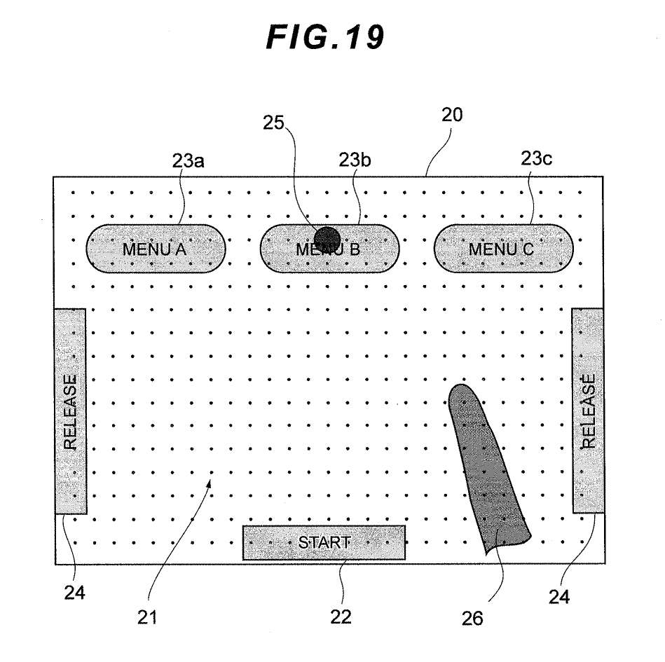

On the other hand, if it is determined that the manipulation object 25 exists in the selection area (step S116: Yes, see FIG. 18), the arithmetic unit 13 releases the finger image 26 follow-up by the manipulation object 25 (step S117). Thereby, as shown in FIG. 19, the manipulation object 25 stays at the menu item 23b. The processing returns to the main routine thereafter.

Referring to FIG. 7 again, in step S108, the arithmetic unit 13 determines whether or not to terminate the manipulations on the manipulation plane 20 in accordance with a predetermined condition. In the present embodiment, as shown in FIG. 19, when the manipulation object 25 is located at any of the menu items, the purpose of the manipulation, which is to select a menu, is achieved and thus, a determination is made to terminate the manipulations. In this case, the arithmetic unit 13 removes the manipulation plane 20 (step S109). Thereby, the series of operations for accepting an input manipulation through the user gestures is terminated. Then, the arithmetic unit 13 executes an operation corresponding to the selected menu (for example, the menu B).

On the other hand, if the manipulations on the manipulation plane 20 are not to be terminated (step S109: No), the processing returns to step S104.

As described above, according to the first embodiment of the present invention, since the manipulation plane is displayed in the virtual space when the user keeps his/her head substantially still, the display can be performed as intended by the user who is trying to start the input manipulation; namely, the manipulation plane will not be displayed even when the user unintentionally places his/her hand over the camera 5 (see FIG. 2) of the image display device 1 or even when an object similar to a hand is accidentally captured by the camera 5, and thus, the user can continue to enjoy viewing the virtual space without being interrupted by the manipulation plane 20.

In addition, according to the present embodiment, the selection target is not selected directly by the image of the particular object used for gestures, and is instead selected via the manipulation object, and thus, the chance of erroneous manipulations can be reduced. For example, in FIG. 18, even if part of the finger image 26 makes contact with the menu item 23c, it will be determined that the menu item 23b where the manipulation object 25 is located is selected. Accordingly, even when a plurality of selection targets are displayed in the manipulation plane, the user can easily perform a desired manipulation.

Furthermore, according to the present embodiment, the state (“on” or “off”) of the determination points 21 is determined and the manipulation object 25 is moved based on this determination result, and the manipulation object 25 can therefore follow the finger image 26 through simple arithmetic processing.

Here, if a dedicated sensor or an external device is provided, in addition to the display device, in order to detect user gestures, the device configuration becomes large. The amount of computation also becomes vast for processing signals detected by the dedicated sensor or the external device, and higher-spec arithmetic devices may therefore be required. Furthermore, if the gesture movement is fast, the arithmetic processing takes time and real-time manipulations may become difficult.

When a plurality of icons are displayed in the virtual space as the user interface, the positional relationship of a manipulation unit with each icon changes each time the manipulation unit is moved. Therefore, if whether or not a manipulation has been made is simply determined based on the positional relationship between the manipulation unit and each icon, there is a possibility that a manipulation may be deemed to have been made to the icon not intended by the user. In this respect, as described in, for example, JP2012-48656 A, if it is to be determined that the manipulation to the icon has been made when a selection instruction has been input with the positional relationship between the icon and the manipulation unit satisfying a predetermined condition, this means that two-phased processing, namely the selection and determination of the icon, is performed and it therefore becomes difficult to say that such manipulation is intuitive to the user.

In contrast, according to the present embodiment, whether or not the image of the object is superimposed is determined for each of a plurality of points provided on the plane and the position of the manipulation object is updated in accordance with this determination result, and the positional change of the image of the particular object, therefore, does not need to be followed-up all the time when updating the position of the manipulation object. Accordingly, even when the image of the particular object moves fast, the manipulation object can easily be placed at the position of the image of the particular object. Consequently, intuitive and real-time manipulations through gestures using a particular object can be performed with a simple device configuration.

More particularly, if the manipulation object 25 follows the finger image 26 by tracking the position of the finger image 26 every time the finger image 26 makes a move, the amount of computation becomes significantly large. Therefore, when the finger image 26 moves fast, the display of the manipulation object 25 may be delayed with respect to the movement of the finger image 26 and there is a possibility that the user's sense of real-time manipulations may be reduced.

In contrast, in the present embodiment, the position of the finger image 26 is not tracked all the time, and the manipulation object 25 is merely moved through determination of the states of the respective determination points 21, which are fixed points, and fast processing therefore becomes possible. In addition, the number of the determination points 21 to be determined is significantly lower than the number of pixels in the display unit 11 and the computational load necessary for the follow-up processing is therefore also light. Accordingly, even when using a small display device, such as a smartphone or the like, real-time input manipulations through gestures can be performed. Moreover, depending on the density setting of the determination points 21, the finger image 26 follow-up precision by the manipulation object 25 can be adjusted and the computational cost can also be adjusted.

It should be understood that the manipulation object 25 moves to the position of the moved finger image 26 in a discrete manner; however, if the determination cycle of the determination points 21 is kept within a few-frame intervals, it appears to the user's eyes that the manipulation object 25 is naturally following the finger image 26.

Furthermore, according to the present embodiment, the start area 11 is provided in the manipulation plane 20 and the user can therefore start manipulations through gestures at a desired timing by superimposing the finger image 26 on the start area 22.

Moreover, according to the present embodiment, the release area 20 is provided in the manipulation plane 20 and the user can therefore release the finger image 26 follow-up processing by the manipulation object 25 at a desired timing and can restart the manipulations through gestures from the beginning.

Here, in the present embodiment, the finger image 26 is superimposed on the start area 22 to trigger the start of the follow-up processing by the manipulation object 25. At this time, the manipulation object 25 moves to a determination point 21 closest to the determination point 21 where the manipulation object 25 is currently located among the determination points 21 that are in the “on” state (i.e. that are superimposed by the finger image 26). Therefore, the manipulation object 25 does not necessarily follow the tip of the finger image 26 (the position of the finger tip). However, even when the manipulation object 25 follows the undesired part of the finger image 26, the user can release the follow-up by the manipulation object 25 by moving the finger image 26 to move the manipulation object 25 to the release area 24. In this manner, the user can repeat the manipulation for starting the follow-up multiple times until the manipulation object 25 follows the desired part of the finger image 26.

### First Variation

In the above-described first embodiment, the intervals and arrangement regions of the determination points 21 provided in the manipulation plane 20 may be appropriately varied. For example, the determination points 21 may be densely arranged to allow the manipulation object 25 to move smoothly. Conversely, the determination points 21 may be sparsely arranged to allow for reduction in computational amount.

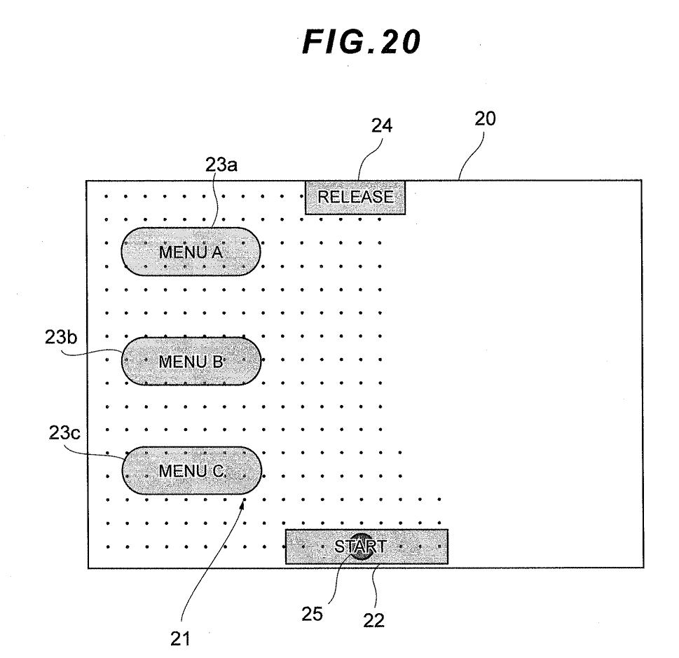

FIG. 20 is a schematic diagram showing another arrangement example of the determination points 21 in the manipulation plane 20. In FIG. 20, the determination points 21 are arranged in limited region of the manipulation plane 20. By selecting the arrangement region of the determination points 21 in this manner, regions where manipulations through gestures are possible can be set.

### Second Variation

In the above-described first embodiment, the follow-up by the manipulation object 25 is started based on the “on” or “off” state of the determination point 21 in the start area 22 and the manipulation object 25 and therefore does not necessarily follow the tip of the finger image 26. In this regard, processing for recognizing the tip of the finger image 26 may be introduced in order to reliably allow the manipulation object 25 to follow the tip part of the finger image 26.

More specifically, when the finger image 26 is superimposed on the start area 22; namely, when any of the determination points 21 associated with the start area 22 turns into the “on” state, the arithmetic unit 13 extracts the contour of the finger image 26 and calculates the curvature as a feature amount of such contour. Then, when the curvature of the contour part that is superimposed on the start area 22 is equal to or larger than a predetermined value, such contour part is determined to be the tip of the finger image 26 and causes the manipulation object 25 to follow this contour part. In contrast, when the curvature of the contour part that is superimposed on the start area 22 is below the predetermined value, such contour part is determined not to be the tip of the finger image 26 and the follow-up by the manipulation object 25 is deferred.

The feature amount used for determining whether or not the contour part that is superimposed on the start area 22 is a tip is not limited to the above-described curvature and various publicly-known feature amounts may be used. For example, the arithmetic unit 13 may set points with predetermined intervals on the contour of the finger image 26 which is superimposed on the start area 22 and, with three successive points being grouped as a group, may calculate an angle between these points. Such angle calculation may be sequentially performed, and if any of the calculated angles is below the predetermined value, the manipulation object 25 follows a point included in the group with the smallest angle. In contrast, when all of the calculated angles are equal to or larger than the predetermined value (provided, however, that they are equal to less than 180°), the arithmetic unit 13 determines that such contour part is not a tip of the finger image 26 and defers the follow-up by the manipulation object 25.

### Third Variation

As another example of processing for recognizing the tip of the finger image 26, a maker having a color different from the skin color may be attached in advance to the tip of the particular object used for gestures (i.e. the user's finger) and such marker may be recognized in addition to the particular object. The method of recognizing the marker is the same as the method of recognizing the particular object, and the color of the marker may be used as the color feature amount. The arithmetic unit 13 may display the image of the recognized marker by adding a particular color (for example, the color of the marker) to the image, in the manipulation plane 20, along with the finger image 26.

In this case, when the finger image 26 is superimposed on the start area 22, the arithmetic unit 13 detects the image of the marker (i.e. the region having the color of the marker) from the manipulation plane 20 and moves the manipulation object 25 to a determination point closest to the image of the marker. Thereby, the manipulation object 25 can follow the tip part of the finger image 26.

Such processing for recognizing the tip may also be applied when selecting a determination point to which the manipulation object 25 is moved (see step S122) in the follow-up processing by the manipulation object 25 (see FIG. 11). More particularly, as shown in FIG. 13, when there is a plurality of determination points that are in the “on” state, the arithmetic unit 13 detects the image of the marker and selects a determination point closest to the image of the marker. Thereby, the manipulation object 25 can continue to follow the tip part of the finger image.

### Second Embodiment

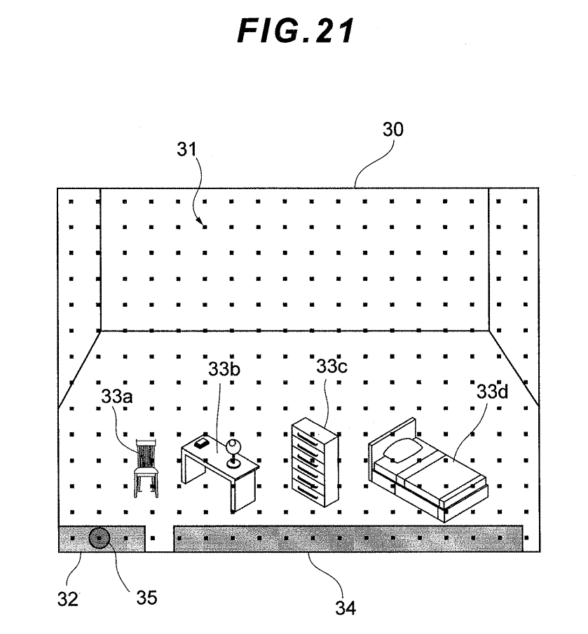

Next, a second embodiment of the present invention will be described. FIG. 21 is a schematic diagram illustrating a manipulation plane deployed in the virtual space in the present embodiment. It should be noted that the configuration of the image display device according to the present embodiment is similar to that shown in FIG. 1.

In the present embodiment, as with the the first embodiment, an image of a particular object and a manipulation object are displayed in a particular screen in the virtual space and the manipulation object is manipulated by means of the image of the particular object. In addition thereto, a three-dimensional object itself placed in the virtual space may be manipulated via the manipulation object.

The manipulation plane 30 shown in FIG. 21 is a user interface for placing a plurality of objects in the virtual space at positions desired by a user, and the case where furniture objects are to be placed in a virtual residential space is shown as an example. A background image, such as a floor, a wall, and the like, of the residential space, is displayed in the background of the manipulation plane 30. The user perceives the furniture objects in a stereoscopic manner with the feeling of being inside the residential space displayed in the manipulation plane 30 by wearing the image display device 1.

A plurality of determination points 31 are provided in the manipulation plane 30 for recognizing the image of the particular object (the below-described finger image 26). The function of the determination points 31 and their states (“on” or “off”) according to their relationships with the image 26 of the particular object are similar to those in the first embodiment (see the determination points 21 in FIG. 5). It should be noted that the determination points 31 may not normally be displayed in the manipulation plane 30.

In addition, a start area 32, a plurality of selection objects 33a to 33d, a release area 34 and the manipulation object 35 are arranged in the manipulation plane 30 in such a manner that they are superimposed on the determination points 31. Among the above elements, the functions of the start area 32, the release area 34 and the manipulation object 35, as well as the finger image 26 follow-up processing, are similar to those of the first embodiment (see steps S111, S112, S114 in FIG. 9).

Here, the start area 32 and the release area 34 are displayed in FIG. 21; however, the start area 32 and the release 34 may normally be hidden. The start area 32 or the release area 34 may only be displayed when the manipulation object 35 is in the start area 32 or approaches the release area 34.

The selection objects 33a to 33d are icons representing pieces of furniture and are configured to move over the determination points 31. The user can place the selection objects 33a to 33d at desired positions in the residential space by manipulating the selection objects 33a to 33d via the manipulation object 35.

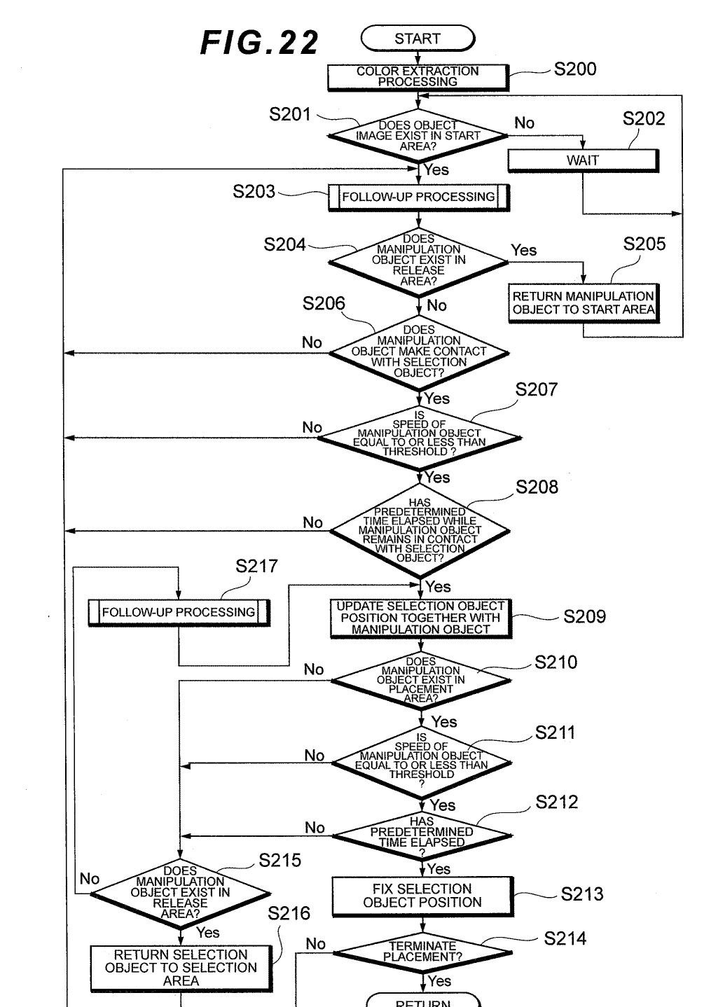

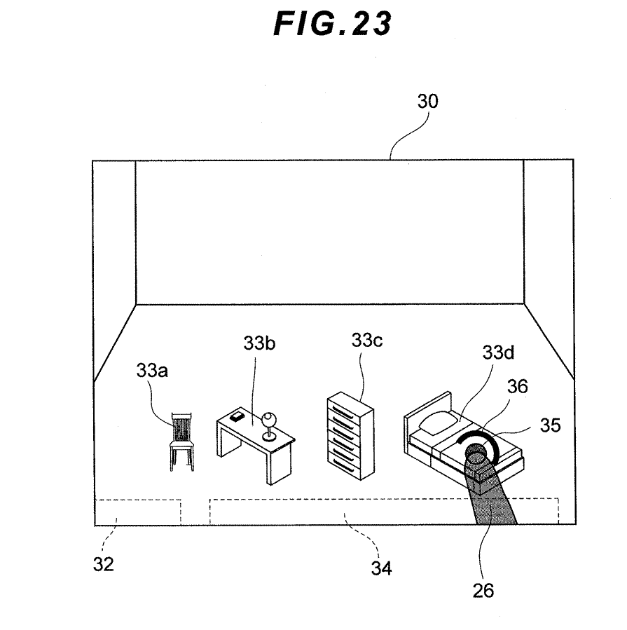

Next, the operations of the image display device according to the present embodiment will be described. FIG. 22 is a flowchart illustrating the operations of the image display device according to the present embodiment and such flowchart illustrates the processing for accepting a manipulation to the manipulation plane 30 displayed on the display unit 11. FIGS. 23 to 29 are schematic diagrams for describing examples of a manipulation to the manipulation plane 30.

Steps S200 to S205 shown in FIG. 22 indicate the corresponding processing of a follow-up start, a follow-up and a follow-up release by the manipulation object 35 of the image of the particular object (i.e. the finger image 26) used for gestures, and they share similarity with steps S110 to S115 shown in FIG. 9.

In step S206 subsequent to step S204, the arithmetic unit 13 determines whether or not the manipulation object 35 makes contact with any of the selection objects 33a to 33d. More specifically, the selection determination unit 138 determines whether or not the determination point 31 (see FIG. 21) at the position of the manipulation object 35 that follows the finger image 26 coincides with the determination point 31 at any of the positions of the selection objects 33a to 33d. For example, in the case of FIG. 23, it is determined that the manipulation object 35 makes contact with the selection object 33d of a bed.

If the manipulation object 35 does not make contact with any of the selection objects 33a to 33d (step S206: No), the processing returns to step S203. On the other hand, if the manipulation object 35 makes contact with any of the selection objects 33a to 33d (step S206: Yes), the arithmetic unit 13 (the selection determination unit 138) subsequently determines whether or not the speed of the manipulation object 35 is equal to or less than a threshold (step S207). This threshold may be set to a value sufficient to allow the user to perceive that the manipulation object 35 is substantially stopped in the manipulation plane 30. This determination is performed based on the frequency of the change in determination points 31 where the manipulation object 35 is located.

If the speed of the manipulation object 35 is faster than the threshold (step S207: No), the processing returns to step S203. On the other hand, if the speed of the manipulation object 35 is equal to or less than the threshold (step S207: Yes), the arithmetic unit 13 (the selection determination unit 138) subsequently determines whether or not a predetermined time has elapsed while the manipulation object 35 remains in contact with the selection object (step S208). Here, as shown in FIG. 23, while the selection determination unit 138 is performing this determination, the arithmetic unit 13 may display a loading bar 36 near the manipulation object 35.

If the manipulation object 35 moves away from the selection object before the predetermined time has elapsed (step S208: No), the processing returns to step S203. On the other hand, if the predetermined time has elapsed while the manipulation object 35 remains in contact with the selection object (step S208: Yes), the arithmetic unit 13 (the selection determination unit 138) updates the position of the selection object being in contact with the manipulation object 35 along with the manipulation object 35 (step S209).

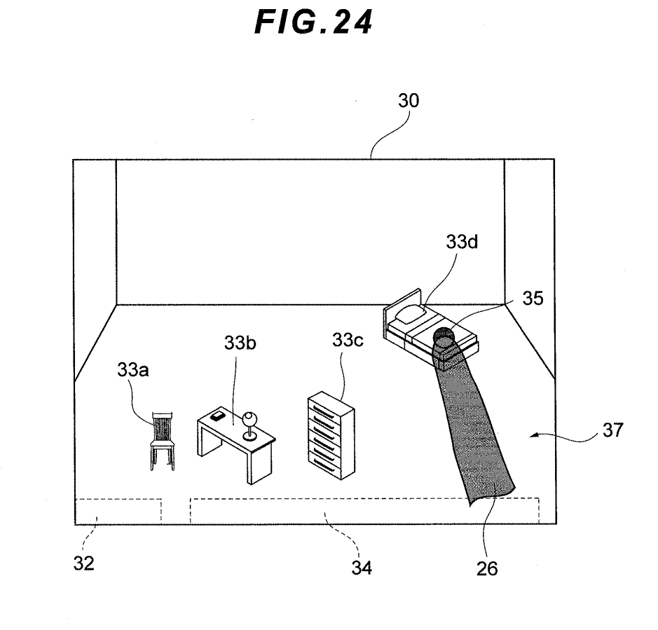

In this manner, as shown in FIG. 24, the selection object 33d moves by following the manipulation object 35; namely, by intentionally stopping the manipulation object 35 that follows the finger image 26 while superimposing the manipulation object 35 on a desired selection object, the user can move such selection object together with the manipulation object 35.

At this time, the arithmetic unit 13 may change the size (scaling) of the moving selection object according to the position in the depth direction and may also adjust the parallax provided between the two screens 11a, 11b (see FIG. 6) for configuring the virtual space. Here, the finger image 26 and the manipulation object 35 are displayed in a two-dimensional manner in a particular plane within the virtual space, whereas the background image of the manipulation plane 30 and the selection objects 33a to 33d are displayed in the virtual space in a three-dimensional manner. Accordingly, when, for example, the selection object 33d is moved toward the back in the virtual space, the manipulation object 35 may be moved in the upper direction in the drawing in the plane in which the finger image 26 and the manipulation object 35 are displayed. It should be noted that the user intuitively moves his/her finger in a three-dimensional manner in the real-life space and thus, the movement of the finger image 26 corresponds to a projection of this finger movement on the two-dimensional plane. At this time, as shown in FIG. 24, by displaying the selection object 33d in a size-diminishing manner the more the selection object 33d moves toward the back (the upper side of the drawing), the user is able to easily feel the sense of depth and can more easily move the selection object 33d to an intended position. When doing so, the ratio of change in scaling of the selection object 33d may be varied depending on the position of the manipulation object 35. Here, the ratio of change in scaling refers to the rate of change in scaling of the selection object 33d with respect to the amount of movement of the manipulation object 35 in the vertical direction in the drawing. More specifically, regarding the case where the manipulation object 35 is at a lower part of the drawing (i.e. on the near side of the floor surface) and the case where the manipulation object 35 is at an upper part of the drawing (i.e. on the far side of the floor surface), the ratio of change in scaling may be increased in the latter case. The ratio of change in scaling may be associated with the positions of the determination points 31.

In the subsequent step S210, the arithmetic unit 13 determines whether or not the manipulation object 35 exists in an area where selection objects 33a to 33d can be placed (placement area). The placement area may be the entire region of the manipulation plane 30 except for the start area 32 and the release area 34 or may be pre-limited to part of the entire region except for the start area 32 and the release area 34. For example, as shown in FIG. 24, only the floor part 37 of the background image of the manipulation plane 30 may be the placement area. The determination is performed based on whether or not the determination point 31 where the manipulation object 35 is located falls within the determination points that are associated with the placement area.

If the manipulation object 35 exists in the placement area (step S210: Yes), the arithmetic unit 13 (the selection determination unit 138) subsequently determines whether or not the speed of the manipulation object 35 is equal to or less than a threshold (step S211). The threshold at this time may have the same value as that of the threshold used in the determination in step S207 or may have a different value.

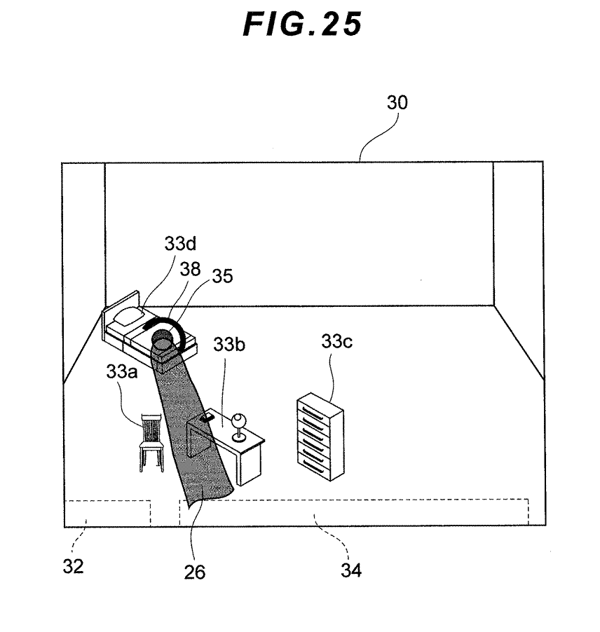

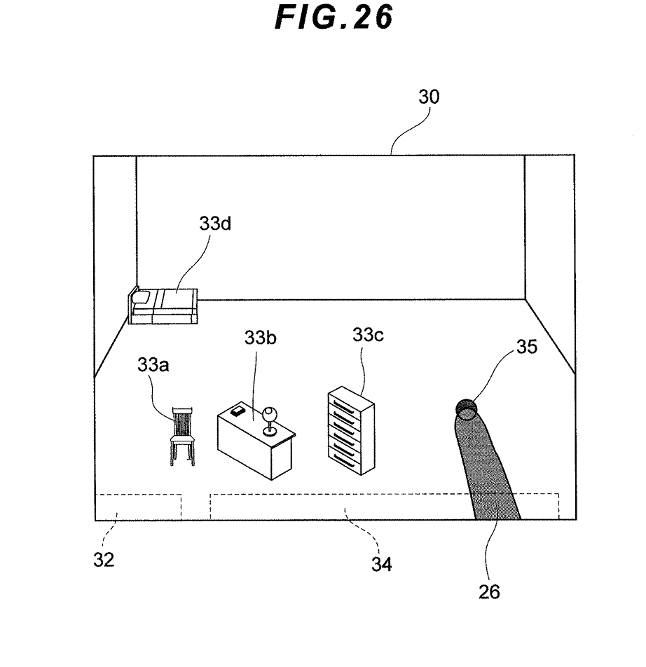

If the speed of the manipulation object 35 is equal to or less than the threshold (step S211: Yes), the arithmetic unit 13 (the selection determination unit 138) subsequently determines whether or not a predetermined time has elapsed while the speed of the manipulation object 35 remains equal to or less than the threshold (step S212). As shown in FIG. 25, while the selection determination unit 138 performs this determination, the arithmetic unit 13 may display a loading bar 38 near the manipulation object 35.

If the predetermined time has elapsed while the speed of the manipulation object 35 remains equal to or less than the threshold (step S212: Yes), the arithmetic unit 13 (the selection determination unit 138) releases the manipulation object 35 follow-up by the selection object and fixes the position of the selection object there (step S213). Thereby, as shown in FIG. 26, only the manipulation object 35 moves again with the finger image 26; namely, by intentionally stopping the manipulation object 35 at a desired position while the selection object follows the manipulation object 35, the user can release the manipulation object 35 follow-up by the selection object and the position of the selection object can be determined.

At this time, the arithmetic unit 13 may appropriately adjust the orientation of the selection object to match the background image. For example, in FIG. 26, the long side of the selection object 33d of the bed is adjusted such that it lies parallel with the background wall.

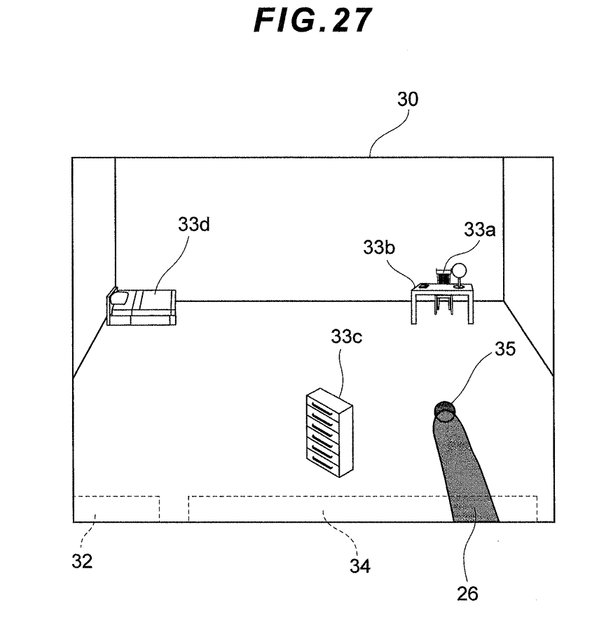

In addition, the arithmetic unit 13 may adjust the anteroposterior relation between the selection objects. For example, as shown in FIG. 27, when the selection object 33a of a chair is placed at the same position as that of the selection object 33b of a desk, the selection objects 33a of the chair may be placed at the front of the selection object 33b of the desk, that is, on the rear side in FIG. 27.

In the subsequent step S214, the arithmetic unit 13 determines whether or not the placement of all the selection objects 33a to 33d has terminated. If the placement has terminated (step S214: Yes), the processing for accepting the manipulation to the manipulation plane 30 terminates. On the other hand, if the placement has not terminated (step S214: No), the processing returns to step S203.

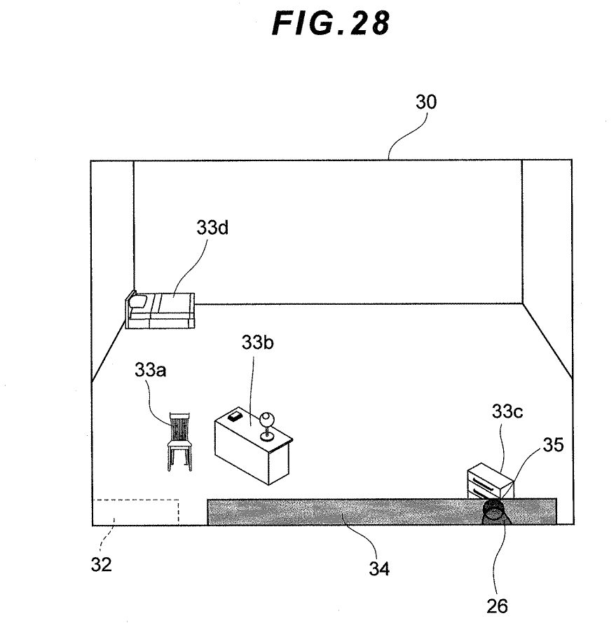

Moreover, if the manipulation object 35 is not present in the placement area (step S210: No), if the speed of the manipulation object 35 is larger than the threshold (step S211: No), or if the manipulation object 35 has moved before the predetermined time has elapsed (step S212: No), the arithmetic unit 13 determines whether or not the manipulation object 35 exists in the release area 34 (step S215). It should be noted that, as described above, the release area 34 may normally be hidden from the manipulation plane 30 and the release area 34 may be displayed when the manipulation object 35 approaches the release area 34. FIG. 28 shows the state in which the release area 34 is displayed.

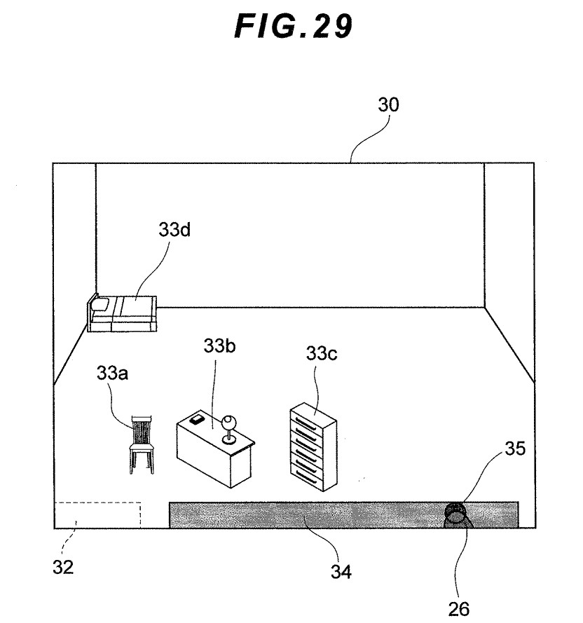

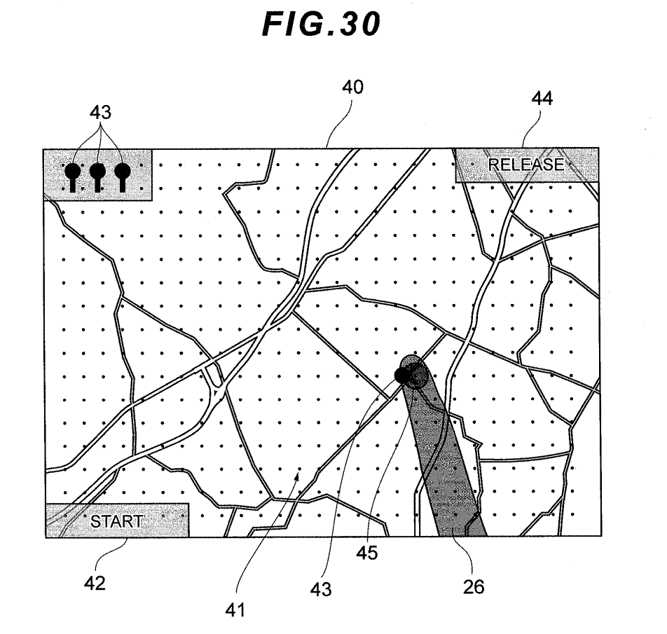

If the manipulation object 35 exists in the release area 34 (step S215: Yes), the arithmetic unit 13 returns the selection object that follows the manipulation object 35 to its initial position (step S216). For example, as shown in FIG. 28, when the manipulation object 35 is moved to the release area 34 while the selection object 33c of a chest is following the manipulation object 35, the follow-up by the selection objects 33c is released and, as shown in FIG. 29, the selection object 33c is again displayed at the original position. The processing returns to step S203 thereafter. Thereby, the user can retry the selection of the selection objects.

On the other hand, if the manipulation object 35 does not exist in the release area 34 (step S216: No), the arithmetic unit 13 continues the finger image 26 follow-up processing by the manipulation object 35 (step S217). The follow-up processing in step S217 is similar to that in step S203. Accordingly, the selection object that is already following the manipulation object 35 also moves with the manipulation object 35 (see step S209).

As described above, according to the second embodiment of the present invention, the user can intuitively manipulate the selection objects through gestures. Accordingly, the user can determine the placement of the objects while checking the sense of presence regarding the objects and the positional relationship among the objects with the feeling of being inside the virtual space.

### Third Embodiment

Next, a third embodiment of the present invention will be described. FIG. 30 is a schematic diagram illustrating a manipulation plane deployed in the virtual space in the present embodiment. It should be noted that the configuration of the image display device according to the present embodiment is similar to that shown in FIG. 1.

The manipulation plane 40 shown in FIG. 30 is provided with a plurality of determination points 41 and a map image is displayed such that it is superimposed on the determination points 41. In addition, a start area 42, selection objects 43, a release area 44 and a manipulation object 45 are placed in the manipulation plane 40. The functions of the start area, the release area 44 and the manipulation object 45, as well as the finger image follow-up processing, are similar to those of the first embodiment (see steps S111, S112, S114 in FIG. 9). It should be noted again that, in the present embodiment, it may not be necessary to display the determination points 41 when displaying the manipulation plane 40 on the display unit 11 (see FIG. 1).

In the present embodiment, the entire map image in the manipulation plane 40, except for the start area 42 and the release area 44, is configured as the placement area for the selection objects 43. In the present embodiment, a pin-type object is displayed as an example of the selection objects 43.

When, in such manipulation plane 40, the manipulation object 45 stops at one of the selection objects 43, with the manipulation object 45 following the finger image 26, and waits for a predetermined time, such selection object 43 starts to move with the manipulation object 45. Moreover, when the manipulation object 45 stops at a desired position on the map and waits for a predetermined time, such selection object 45 is fixed at that location. Thereby, a point on the map is selected which corresponds to a determination point 41 where the selection object 43 is located.

The manipulation plane 40 that selects a point on the map in this manner can be applied in different applications. As an example, when a spot is selected in the manipulation plane 40, the arithmetic unit 13 may close the manipulation plane 40 once and display the virtual space corresponding to the selected spot. Thereby, the user can have an experience as if he/she has instantly moved to the selected spot. As another example, when two spots are selected in the manipulation plane 40, the arithmetic unit 13 may calculate a route on the map between the selected two spots and display the virtual space having scenery that varies along such route.

The present invention is not limited to the above-described first to third embodiments and variations, and various inventions can be made by appropriately combining a plurality of components disclosed in the above-described first to third embodiments and variations. For example, inventions can be made by omitting certain components from the entirety of the components shown in the first to third embodiments and variations, or by appropriately combining the components shown in the first to third embodiments and variations.

Further advantages and modifications may be easily conceived of by those skilled in the art. Accordingly, from a wider standpoint, the present invention is not limited to the particular details and representative embodiments described herein. Accordingly, various modifications can be made without departing from the spirit or scope of the general idea of the invention defined by the appended claims and equivalents thereof.

What is claimed is:

1. An image display device that is capable of displaying a screen for allowing a user to perceive a virtual space, comprising:
an outside information obtaining unit that obtains information related to a real-life space in which the image display device exists;
an object recognition unit that recognizes, based on the information, a particular object that exists in the real-life space;
a pseudo three-dimensional rendering processing unit that places an image of the object in a particular plane within the virtual space;
a virtual space configuration unit that provides, in the plane, a plurality of determination points used for recognizing the image of the object and that places, in the plane, a manipulation object that is manipulated by the image of the object and that moves over the plurality of determination points;
a state determination unit that determines whether each of the plurality of determination points is in either a first state, in which the image of the object is superimposed, or in a second state, in which the image of the object is not superimposed; and
a position update processing unit that updates a position of the manipulation object depending on a determination result by the state determination unit.

2. The image display device according to claim 1, wherein the position update processing unit updates the position of the manipulation object to a position of a determination point that is in the first state.

3. The image display device according to claim 2, wherein, when a plurality of determination points that are in the first state is present, the position update processing unit updates the position of the manipulation object to a position of a determination point that meets a predetermined condition.

4. The image display device according to claim 1, wherein, when it is determined, by the state determination unit, that the image of the object is superimposed on at least one of the plurality of determination points, the at least one determination point being pre-provided as a start area, the position update processing unit starts updating the position of the manipulation object.

5. The image display device according to claim 1, wherein, when the position of the manipulation object is updated to at least one of the plurality of determination points, the at least one determination point being pre-provided as a release area, the position update processing unit terminates updating the position of the manipulation object.

6. The image display device according to claim 5, wherein, when updating the position of the manipulation object is terminated, the position update processing unit updates the position of the manipulation object to the at least one determination point that is provided as the start area.

7. The image display device according to claim 1, wherein the virtual space configuration unit places a selection object in a region that includes at least one pre-provided determination point out of the plurality of determination points, the image display device further comprising:
a selection determination unit that determines that the selection object has been selected when the position of the manipulation object is updated to the at least one determination point in the region.

8. The image display device according to claim 1, wherein the virtual space configuration unit places, in the plane, a selection object that is capable of moving over the plurality of determination points, the image display device further comprising:
a selection determination unit that updates a position of the selection object together with the position of the manipulation object when the position of the manipulation object is updated to a determination point where the selection object is located and when a predetermined time has elapsed.

9. The image display device according to claim 8, wherein, while in the state in which the position of the selection object is updated together with the position of the manipulation object, when a speed of the manipulation object is equal to or less than a threshold and a predetermined time has elapsed, the selection determination unit stops updating the position of the selection object.

10. The image display device according to claim 1, wherein the outside information obtaining unit is a camera incorporated in the image display device.

11. An image display method that is executed by an image display device that is capable of displaying a screen for allowing a user to perceive a virtual space, comprising the steps of:
(a) obtaining information related to a real-life space in which the image display device exists;
(b) recognizing, based on the information, a particular object that exists in the real-life space;
(c) placing an image of the object in a particular plane within the virtual space;
(d) providing, in the plane, a plurality of determination points used for recognizing the image of the object and placing, in the plane, a manipulation object that is manipulated by the image of the object and that moves over the plurality of determination points;
(e) determining whether each of the plurality of determination points is in either a first state, in which the image of the object is superimposed, or in a second state, in which the image of the object is not superimposed; and
(f) updating a position of the manipulation object depending on a determination result in step (e).

12. A computer-readable recording device having an image display program stored thereon to be executed by an image display device that is capable of displaying a screen for allowing a user to perceive a virtual space, the image display program causing the image display device to execute the steps of:
(a) obtaining information related to a real-life space in which the image display device exists;
(b) recognizing, based on the information, a particular object that exists in the real-life space;
(c) placing an image of the object in a particular plane within the virtual space;
(d) providing, in the plane, a plurality of determination points used for recognizing the image of the object and placing, in the plane, a manipulation object that is manipulated by the image of the object and that moves over the plurality of determination points;
(e) determining whether each of the plurality of determination points is in either a first state, in which the image of the object is superimposed, or in a second state, in which the image of the object is not superimposed; and
(f) updating a position of the manipulation object depending on a determination result in step (e).
